(19) United States
(12) Patent Application Publication
(10) Pub. No.: US 2025/0270851 A1
(43) Pub. Date: Aug. 28, 2025

(54) DOUBLE LOCK SYSTEM

(71) Applicant: Port Security Systems LLC, Suwanee, GA (US)

(72) Inventor: Rafi Syed, Suwanee, GA (US)

(73) Assignee: Port Security Systems LLC, Suwanee, GA (US)

(21) Appl. No.: 19/060,719

(22) Filed: Feb. 23, 2025

Related U.S. Application Data
(60) Provisional application No. 63/557,280, filed on Feb. 23, 2024.

(51) Int. Cl. E05B 59/00; E05B 13/00; E05B 47/00; E05B 63/00

(52) U.S. Cl. CPC E05B 59/00; E05B 13/002; E05B 47/0001; E05B 63/0017; E05B 63/0065

(57) ABSTRACT

A double lock system enhances door security while simplifying operation. The system features an exterior body and an interior body attached to opposite sides of a door. A handle lock mechanism and a deadbolt lock mechanism are integrated into both bodies and synchronized by a linkage apparatus. The linkage apparatus includes a top element engaging a cam of the deadbolt mechanism, a bottom element engaging a locking pin of the handle mechanism, and a connecting spring linking the two. An actuator attached to the deadbolt mechanism triggers simultaneous actuation of both locks. Wireless connectivity via a transceiver and a user-operated mode selector enable remote operation and multiple locking configurations. In one embodiment, a single cylinder unlocks both the handle and deadbolt mechanisms, providing enhanced security and ease of use with a single application.

### CROSS-REFERENCE TO RELATED APPLICATIONS

This application claims benefit of priority with U.S. Provisional Application Ser. No. 63/557,280, filed Feb. 23, 2024; the entire contents of which are hereby incorporated by reference.

### BACKGROUND

### Field of the Invention

This disclosure relates to a locking system, and more particularly to a double lock system remotely controllable by a single application.

### Description of the Related Art

Smart locks are increasingly popular, particularly in settings such as short-term rentals. Typically, a single smart lock, usually a smart deadbolt, is paired with a conventional passage lever set, allowing for easy wireless control and access. However, using only one lock can compromise security. Although employing two smart locks can enhance security, this approach often requires two separate applications for control, reducing convenience. There is, therefore, a need for a double lock system that increases security while still allowing both locks to be controlled through a single application.

### SUMMARY

A double lock system is disclosed. The double lock system comprises an interior body and an exterior body. The double lock system comprises a handle lock mechanism and a deadbolt lock mechanism each disposed in the interior body and the exterior body. The handle lock mechanism is synchronously coupled to the deadbolt lock mechanism for simultaneous actuation. The double lock system is configured to remotely actuate both the deadbolt lock mechanism and the handle lock mechanism by a single software application.

In one aspect, a method of actuating a double lock system comprises: (i) receiving a signal from an application; (ii) actuating at least one of a deadbolt lock mechanism and a handle lock mechanism, the deadbolt lock mechanism being synchronously coupled to the handle lock mechanism; and (iii) unlocking each of the deadbolt lock mechanism and the handle lock mechanism.

In one aspect, a method of changing locking modes of a double lock system comprises: (i) receiving a signal from a mode selector, the mode selector being disposed externally on the double lock system, the mode selector being configured to be manually activated by a user; (ii) selecting one of a plurality of locking modes not currently used by the double lock system, the plurality of locking modes comprising a standard mode, a passage mode, and a lock mode; and (iii) actuating at least one of the deadbolt lock mechanism and the handle lock mechanism to align with the selected mode, the deadbolt lock mechanism being synchronously coupled to the handle lock mechanism.

### BRIEF DESCRIPTION OF THE DRAWINGS

Other features, combinations, and embodiments will be appreciated by one having the ordinary level of skill in the art of locks upon a thorough review of the following details and descriptions, particularly when reviewed in conjunction with the drawings, wherein:

FIG. 1 shows a side view of the double lock system in accordance with a first illustrated embodiment;

FIG. 2 shows a front view of an exterior body of the double lock system according to the first illustrated embodiment;

FIG. 3 shows a front view of an interior body of the double lock system according to the first illustrated embodiment;

FIG. 4 shows a block diagram of the double lock system according to the first illustrated embodiment;

FIG. 5 shows a front view of the inner surface of the exterior body and the interior body according to the first illustrated embodiment;

FIG. 6 shows an internal view of the interior body according to the first illustrated embodiment;

FIG. 7 shows an internal view of the exterior body according to the first illustrated embodiment;

FIG. 8 shows a front view of a linkage apparatus according to the first illustrated embodiment;

FIG. 9A shows a block diagram of the double lock system according to an embodiment;

FIG. 9B shows a block diagram of the double lock system according to an alternative embodiment;

FIG. 9C shows a block diagram of the double lock system according to an alternative embodiment;

FIG. 10 shows a front view of a linkage apparatus in accordance with a second illustrated embodiment;

FIG. 11A shows a perspective view of a support adapter in accordance with a third illustrated embodiment; and

FIG. 11B shows an alternate perspective view of the support adapter according to the third illustrated embodiment.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

The features, components, and configurations described in connection with the various embodiments illustrated herein may be combined, interchanged, or otherwise modified in any number of ways without departing from the scope and spirit of the invention. The embodiments are presented by way of example and not limitation, and it is intended that the invention encompasses all such combinations, permutations, and modifications as would be understood by those skilled in the art.

For purposes herein, the term “actuation” means to change from a locked position to an unlocked position, or from an unlocked position to a locked position.

The term “actuator” means any electromechanical device configured to actuate a locking mechanism. Actuator can include motors and solenoids.

The term “handle” means knob, lever, or any other device configured to open and close a door.

The term “synchronously coupled” means to be mechanically coupled, electronically coupled, or both such that rotation of one element is transferred to the other.

The term “simultaneous” means occurring based on a single action by a user.

The term “locking pin” means a pin within the handle lock mechanism that engages with other components of the handle lock mechanism to prevent the handle from being turned.

Unless explicitly defined herein, terms are to be construed in accordance with the plain and ordinary meaning as would be appreciated by one having skill in the art.

### General Description of Embodiments

In one general embodiment, a double lock system is disclosed. The double lock system comprises an exterior body having a first inner surface, a first outer surface opposite the first inner surface, and a first internal cavity disposed between the first inner surface and the first outer surface, wherein the first inner surface is configured to abut an exterior side of a door. The double lock system further comprises an interior body mechanically and electrically coupled to the exterior body. The interior body has a second inner surface, a second outer surface opposite the second inner surface, and a second internal cavity disposed between the second inner surface and the second outer surface, wherein the second inner surface is configured to abut an interior side of a door. The double lock system further comprises a handle lock mechanism integrated within each of the interior body and the exterior body, the handle lock mechanism comprising an outer handle disposed on the first outer surface of the exterior body and an inner handle disposed on the second outer surface of the interior body. The handle lock mechanism further comprises a locking pin disposed inside at least one of the first internal cavity or the second internal cavity. The double lock system further comprises a deadbolt lock mechanism integrated within each of the interior body and the exterior body, the deadbolt lock mechanism comprising a cam and a deadbolt cylinder, the deadbolt cylinder disposed on the first outer surface of the exterior body, the deadbolt cylinder having a keyway configured to receive a key for manual actuation of a deadbolt, the deadbolt lock mechanism further comprising a thumb turn disposed on the interior body at the second outer surface, the thumb turn being mechanically coupled to the deadbolt. The double lock system further comprises a transceiver disposed inside at least one of the first internal cavity and the second internal cavity. A linkage apparatus is disposed inside one of the first internal cavity or the second internal cavity. The linkage apparatus is coupled to both the handle lock mechanism and the deadbolt lock mechanism to form a synchronous coupling between the handle lock mechanism and the deadbolt lock mechanism. The linkage apparatus comprises a top element comprising a top flange engaged with the cam of the deadbolt lock mechanism, a bottom element comprising a bottom flange engaged with the locking pin of the handle lock mechanism, and a connecting spring coupling the top element to the bottom element. The double lock system further comprises an actuator coupled to the deadbolt lock mechanism wherein actuation of the deadbolt cylinder synchronously actuates the handle lock mechanism via the linkage apparatus.

In some embodiments, the double lock system may further comprise a mode selector disposed on the second outer surface of the interior body, wherein the mode selector is configured to be manually pressed to alter locking modes of the double lock system.

In some embodiments, the double lock system may further comprise a single cylinder configured to unlock both the handle lock mechanism and the deadbolt lock mechanism, wherein the single cylinder is the deadbolt cylinder integrated with the deadbolt lock mechanism.

In some embodiments, the double lock system may further comprise a router and a gateway communicatively coupled to the router by a first wireless communication protocol, the gateway further communicatively coupled to the transceiver by a second wireless communication protocol, wherein the first wireless communication protocol is different from the second wireless communication protocol.

In some embodiments, the double lock system may further comprise a spring sheath covering the connecting spring.

In some embodiments, the top flange and the bottom flange may each comprise a concave formation.

In some embodiments, the double lock system may further comprise a support adapter coupled to the first inner surface of the exterior body, the support adapter comprising a raised periphery, the raised periphery having a plurality of quadrants comprising a top quadrant, a bottom quadrant, a first lateral quadrant, and a second lateral quadrant wherein the raised periphery at the top quadrant and the bottom quadrant is taller than the raised periphery at the first lateral quadrant and the second lateral quadrant.

In another general embodiment, a double lock system is disclosed. The double lock system comprises an exterior body having a first inner surface, a first outer surface opposite the first inner surface, and a first internal cavity disposed between the first inner surface and the first outer surface, wherein the first inner surface is configured to abut an exterior side of a door. The double lock system further comprises an interior body coupled to the exterior body, the interior body having a second inner surface, a second outer surface opposite the second inner surface, and a second internal cavity disposed between the second inner surface and the second outer surface, wherein the second inner surface is configured to abut an interior side of a door. A handle lock mechanism is integrated within each of the interior body and the exterior body. A deadbolt lock mechanism is integrated within each of the interior body and the exterior body. The handle lock mechanism is synchronously coupled to the deadbolt lock mechanism for simultaneous actuation.

In some embodiments, the interior body may be electrically coupled and mechanically coupled to the exterior body.

In some embodiments, the handle lock mechanism may further comprise an outer handle disposed on the first outer surface of the exterior body and an inner handle disposed on the second outer surface of the interior body.

In some embodiments, the deadbolt lock mechanism may further comprise a deadbolt cylinder disposed on the first outer surface of the exterior body, the deadbolt cylinder including a keyway configured to receive a key for manual actuation of a deadbolt. The deadbolt lock mechanism may further comprise a thumb turn disposed on the interior body at the second outer surface, the thumb turn being mechanically coupled to the deadbolt. In some embodiments, the handle lock mechanism may be coupled to the deadbolt cylinder wherein actuation of the deadbolt cylinder synchronously actuates the handle lock mechanism.

In some embodiments, the double lock system may further comprise a mode selector disposed on the second outer surface of the interior body, wherein the mode selector is configured to be manually pressed to alter locking modes of the double lock system.

In some embodiments, the double lock system may further comprise a single cylinder configured to unlock both the handle lock mechanism and the deadbolt lock mechanism, wherein the single cylinder is a deadbolt cylinder integrated with the deadbolt lock mechanism.

In some embodiments, the double lock system may further comprise a transceiver for receiving signals for remote actuation. The system may further comprise a router and a gateway communicatively coupled to the router by a first wireless communication protocol, the gateway further communicatively coupled to the transceiver by a second wireless communication protocol, wherein the first wireless communication protocol is different from the second wireless communication protocol.

In some embodiments, the double lock system may further comprise a linkage apparatus coupled to both the deadbolt lock mechanism and the handle lock mechanism. The system may further comprise an actuator coupled to the deadbolt lock mechanism. The linkage apparatus may further comprise a top element and a bottom element coupled together by a connecting spring, wherein the top element comprises a top flange and the bottom element comprises a bottom flange. In some embodiments, the linkage apparatus further comprises a spring sheath covering the connecting spring. The top flange and the bottom flange may each comprise a concave formation. The top flange may engage with a cam of the deadbolt lock mechanism. The bottom flange may engage with a locking pin of the handle lock mechanism.

In some embodiments, the double lock system may further comprise a support adapter coupled to the first inner surface of the exterior body, the support adapter comprising a raised periphery, the raised periphery having a plurality of quadrants comprising a top quadrant, a bottom quadrant, a first lateral quadrant, and a second lateral quadrant wherein the raised periphery at the top quadrant and the bottom quadrant is taller than the raised periphery at the first lateral quadrant and the second lateral quadrant.

### Manufacturing

Generally, the double lock system is made of metals, thermoplastic, or a combination thereof. Otherwise, the double lock system can be fabricated in accordance with the level and knowledge of one having skill in the art

The cylinders can be obtained commercially from manufacturers such as Schlage or Kwikset. Alternatively, the shield can be customized in accordance with the level and knowledge of one having skill in the art. The cylinders may comprise IC core cylinders which are especially useful for building owners to replace cylinders.

The actuators may comprise solenoids or motors. The motors may comprise a DC or stepped motor. The motors are configured to drive by a gear mechanism that extends or retracts a deadbolt or other locking mechanism. The solenoids may comprise a fail-secure mode wherein the lock remains in a locked position when power is lost.

The exterior and interior body of the double lock system may be configured to fit on pre-board 2-hole doors. Center to center of the two holes may be spaced apart by 4″ or 5.5″. The deadbolt and spring latch may comprise fireproof quality certified for 1.5 to 3 hours.

Each of the components of the double lock system described herein may be manufactured and/or assembled in accordance with the conventional knowledge and level of a person having skill in the art.

While various details, features, combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### Illustrated Embodiments

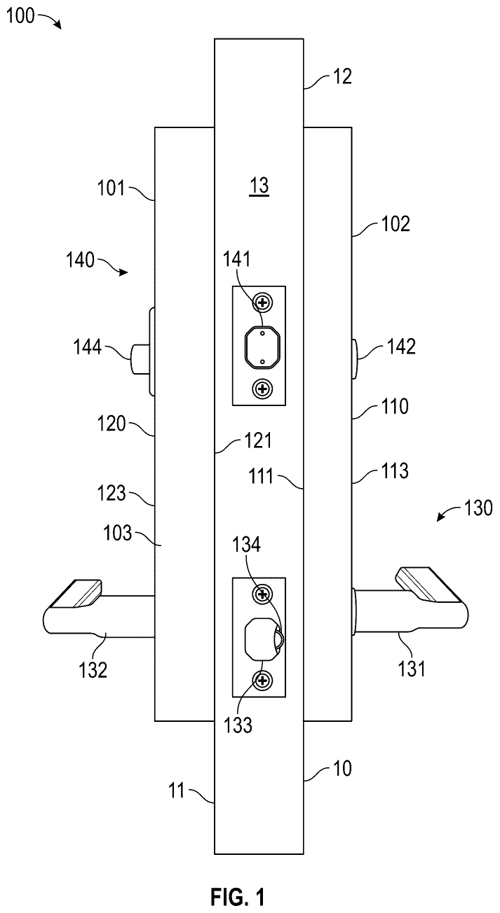

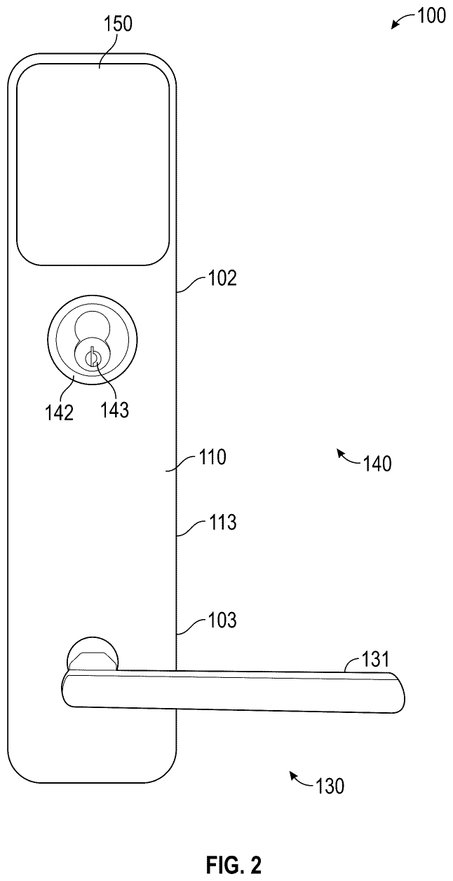

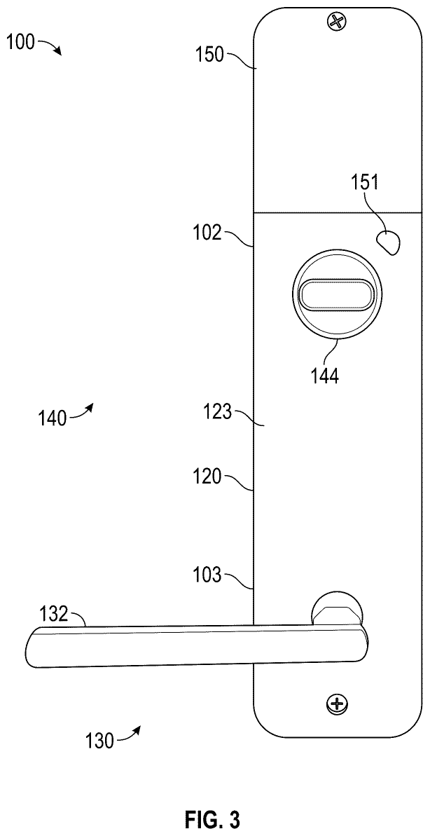

Now turning to the drawings, FIGS. 1-3 show a double lock system (100) in accordance with a first illustrated embodiment. The double lock system is disposed on an interior side (11) and an exterior side (12) of a door (10). The double lock system comprises an exterior body (110) and an interior body (120) wherein the exterior body and the interior body are mechanically and electrically coupled to each other. The exterior body comprises a first inner surface (111) and a first outer surface (113) opposite the first inner surface wherein the first inner surface abuts the exterior side of the door. The interior body comprises a second inner surface (121) and a second outer surface (123) opposite the second inner surface wherein the second inner surface abuts to the interior side of the door.

The double lock system (100) further comprises a handle lock mechanism (130) and a deadbolt lock mechanism (140) wherein each of the mechanisms is integrated in both the exterior body (110) and the interior body (120). The handle lock mechanism is disposed at a lower region (103) of the double lock system, and the deadbolt lock mechanism is disposed above the handle lock mechanism at an upper region (102). The handle lock mechanism comprises an outer handle (131) disposed on the first outer surface (113) of the exterior body, and an inner handle (132) disposed on the second outer surface (123) of the interior body. In some embodiments, the inner and outer handles are synchronously coupled such that rotation of one rotates the other. In other embodiments, the inner and outer handles are asynchronously coupled such that the inner and outer handles independently actuate a spring latch (133) extending from a lock edge (13) of the door (10). The spring latch further comprises a deadlocking plunger (134). The handle lock mechanism is configurable into a locked position and an unlocked position. The handle lock mechanism is devoid of a cylinder disposed within the handle lock mechanism and instead the handle lock mechanism couples to a deadbolt cylinder (142) of the deadbolt lock mechanism.

The deadbolt lock mechanism (140) comprises the deadbolt cylinder (142) disposed on the first outer surface (113) of the exterior body (110). The deadbolt cylinder includes a keyway (143) for receiving a key for manual actuation of a deadbolt (141). The deadbolt is configured to extend from the lock edge (13) of the door (10) while in the locked position. The deadbolt lock mechanism further comprises a thumb turn (144) disposed on the interior body (120) at the second outer surface (123). The thumb turn is mechanically coupled to the deadbolt and is configured for manual actuation of the deadbolt upon rotation of the thumb turn.

The double lock system (100) further comprises a touch pad (150) disposed on each of the exterior body (110) and interior body (120). In other embodiments, only the exterior body comprises the touch pad for receiving a number password from a user. The interior body may comprise a display screen. A mode selector (151) is disposed on the second outer surface (123) of the interior body near the thumb turn (144). The mode selector is shown as a button and is configured to be manually pressed by a user to change locking modes of the double lock system.

The double lock system (100) comprises a single cylinder, being the deadbolt cylinder (142), which is configured to unlock both the deadbolt lock mechanism (140) and the handle lock mechanism (130). The double lock system further comprises smart home technology and is configured to receive wireless signals for remote operation. Means of unlocking the double lock system includes a software application, passcode, smart card, NFC, Wi-Fi, Bluetooth, RFID, or a combination thereof. The double lock system as shown and described allows both locking mechanisms to be controlled with a single application. These embodiments allow for increased security with a two-lock system without requiring the use of two separate applications independently controlling both locks.

The handle lock mechanism (130) and the deadbolt lock mechanism (140) are synchronously coupled together such that actuation of one actuates the other. For example, in some embodiments, when the deadbolt cylinder (142) or thumb turn (144) is engaged, both the deadbolt (141) and the spring latch (133) will unlock together and lock together. In some embodiments, while the exterior body (110) is locked and the deadbolt is in the locked position, the inner handle (132) can be turned to unlock and retract both the spring latch and the deadbolt. The spring latch can retract back into a locked position after the door is closed to maintain the handle lock mechanism in a locked state relative to the exterior body. The exterior body can achieve the locked state by preventing rotation of the outer handle (131) or by preventing the outer handle from retracting the locked spring latch. Other means can be utilized as can be appreciated by one having skill in the art.

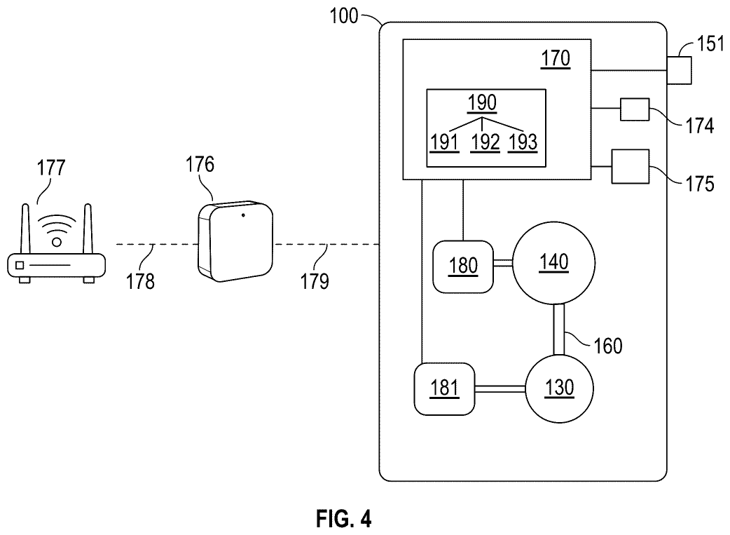

FIG. 4 shows a block diagram of the double lock system (100) according to the first illustrated embodiment. The double lock system is configurable for both manual and remote actuation. Remote actuation can be accomplished with wireless communication using a router (177). In some embodiments, the router is communicatively coupled to a gateway (176) by a first wireless communication protocol (178), and the gateway is communicatively coupled to the double lock system via a transceiver (174) by a second wireless communication protocol (179) such that the first wireless communication protocol is different from the second wireless communication protocol. In some embodiments, the first wireless communication protocol may be Wi-Fi and the second wireless communication protocol may be Bluetooth to mitigate the risk of hacking into the double lock system. Preferably, the gateway is spaced close enough to the double lock system to ensure robust communication. In some embodiments, the gateway is spaced about 8 ft from the double lock system.

Wireless signals from the gateway (176), router (177), or other wireless devices are received by the transceiver (174) disposed within the double lock system (100). The transceiver is communicatively coupled with an electronic control circuit (170). The electronic control circuit receives power from a power supply (175) being batteries, AC power, or both. The electronic control circuit is also configured to receive signals from a mode selector (151) disposed externally on the interior body. The mode selector can be pressed, or otherwise engaged, by a user to send a signal to the electronic control circuit for changing the double lock system into one of a plurality of locking modes (190). The plurality of locking modes includes a standard mode (191), a passage mode (192), and a locked mode (193). The electronic control circuit is further configured to receive signals from a touch pad.

The standard mode (191) comprises a one-way locked configuration to allow egress for exiting a dwelling. The double lock system is locked from the outside but can be opened from the inside even when a deadbolt in the double lock system is in a locked position. Due to the handle lock mechanism (130) and the deadbolt lock mechanism (140) being synchronously coupled via a linkage apparatus, once the handle lock mechanism is opened from the inside, the deadbolt retracts to actuate the double lock system into an unlocked position. The standard mode can be useful in cases of emergency. In some embodiments, the standard mode is achieved by having an inner handle be unlocked while the outer handle is locked. The outer handle can be locked by being incapable of rotation, or it can rotate but is unable to engage and retract a spring latch.

The passage mode (192) comprises an unlocked configuration where egress into and out of the dwelling are both possible. The exterior and the interior bodies of both lock mechanisms are unlocked which include the deadbolt, the inner handle, and the outer handle. The passage mode can be used temporarily when entry and exit of the dwelling is frequent, like when groceries are being collected and stored inside.

The locked mode (193) comprises a two-way locked configuration where egress into and out of the dwelling are both not possible. The deadbolt of the deadbolt lock mechanism (140) is in a locked position, as well as the spring latch of the handle lock mechanism (130). The locked mode can be useful to prevent young children from leaving the dwelling. During the locked mode, the interior body is locked compared to the standard mode. In some embodiments, the inner handle of the handle lock mechanism is incapable of rotation which prevents both the spring latch and the deadbolt from unlocking. Alternatively, the inner handle is capable of rotation but is unable to retract the spring latch, which in turn does not unlock the deadbolt.

In some embodiments, the plurality of modes (190) may further comprise a reversed mode of the standard mode, wherein the double lock system is unlocked from the outside but locked from the inside. Similar to the passage mode, this mode can be useful when ease of entry is desired but the inside is locked to prevent a child from leaving the dwelling.

The electronic control circuit (170) is configured to actuate the handle lock mechanism (130) and the deadbolt lock mechanism (140) based on the locking mode selected. The electronic control circuit is configured to send signals to a first actuator (180) and a second actuator (181). The first actuator is mechanically coupled to the deadbolt lock system and the second actuator is mechanically coupled to the handle lock mechanism. The handle lock mechanism and the deadbolt lock mechanism are further synchronously coupled by a linkage apparatus (160). In some embodiments, the double lock system comprises a single actuator configured to actuate one of the handle lock mechanism or the deadbolt lock mechanism, and the linkage apparatus is configured to actuate the other of the lock mechanisms accordingly.

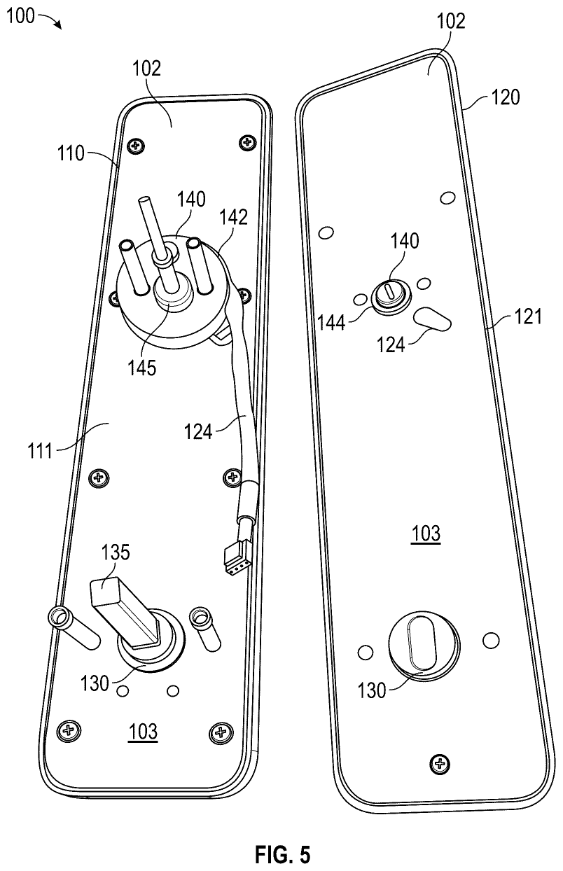

FIG. 5 shows inner surfaces of the exterior body (110) and the interior body (120) according to the first illustrated embodiment. The exterior body comprises a first inner surface (111) configured to abut an exterior side of a door, and the interior body comprises a second inner surface (121) configured to abut an interior side of the door. The exterior body and the interior body each comprise portions of a handle lock mechanism (130) disposed at a lower region (103) thereof. Additionally, the exterior body and the interior body each comprise portions of a deadbolt lock mechanism (140) disposed at an upper region (102) thereof. The exterior body and the interior body are configured to mechanically and electronically couple together. Mechanical coupling is achieved by a spindle (135) of the handle lock mechanism and a tailpiece (145) of the deadbolt lock mechanism. The spindle allows both inner and outer handles to engage the handle lock mechanism simultaneously. The spindle extends from a deadbolt cylinder (142) to a thumb turn (144). When a key is inserted and turned or the thumb turn is used, the tailpiece rotates, activating the deadbolt to lock or unlock the door. Electronic coupling is achieved by a circuit harness (173) electrically coupled to a first module of an electronic control circuit (not shown) disposed inside the exterior body, and a second module of the electronic control circuit (not shown) disposed inside the interior body. The second inner surface of the interior body comprises a harness aperture (124) for receiving the circuit harness.

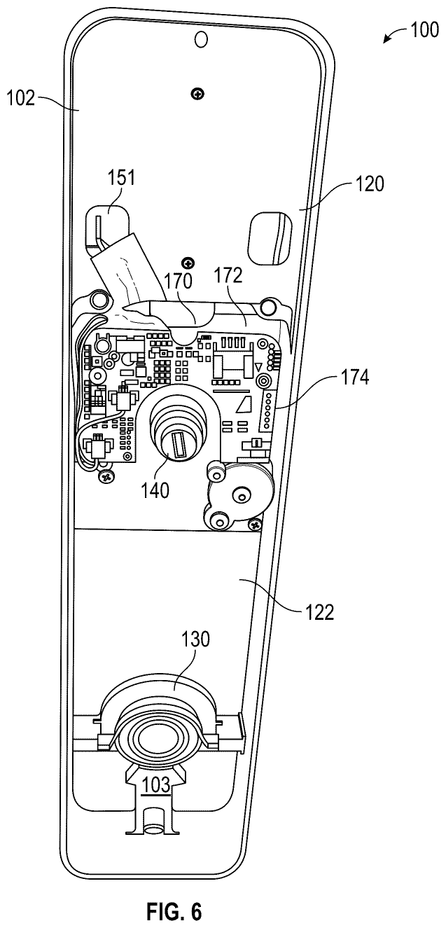

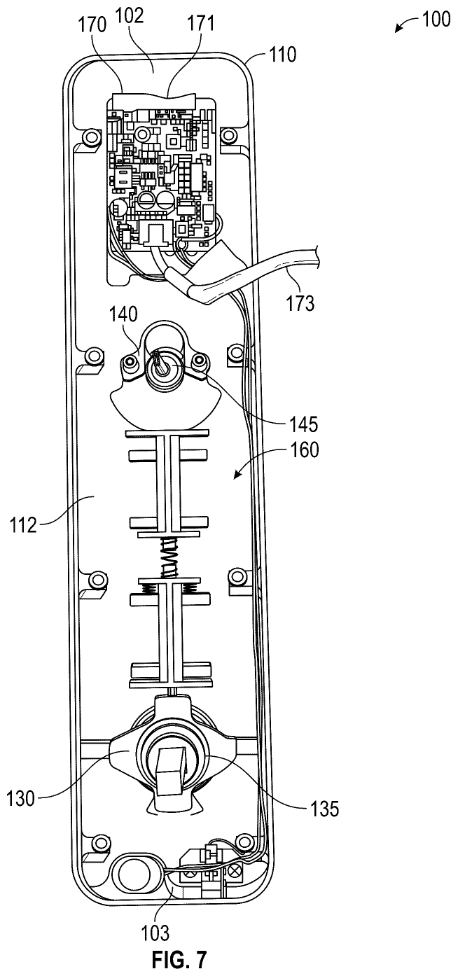

FIGS. 6-7 show internal views of the interior body (120) and the exterior body (110) according to the first illustrated embodiment. The exterior body comprises a first internal cavity (112). The exterior body includes portions of a handle lock mechanism (130) and a deadbolt lock mechanism (140). The first internal cavity further comprises a first module (171) of an electronic control circuit (170). The handle lock mechanism and the deadbolt lock mechanism are synchronously coupled with a linkage apparatus (160). The interior body comprises a second internal cavity (122). The interior body includes portions of the handle lock mechanism and the deadbolt lock mechanism. The second internal cavity further comprises a second module (172) of the electronic control circuit. The second module of the interior body is electronically coupled to the first module of the exterior body by a circuit harness (173). In some embodiments, the second module comprises a transceiver (174) due to its proximity to an interior of the dwelling.

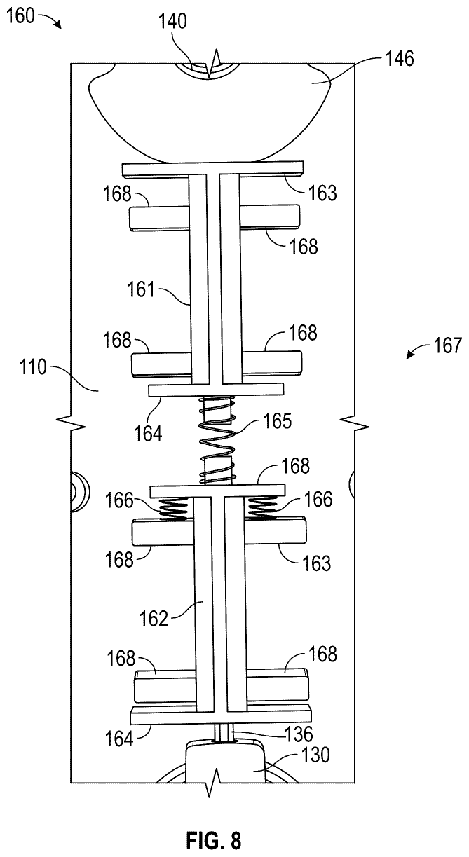

FIG. 8 shows a front view of a linkage apparatus (160) according to the first illustrated embodiment. The linkage apparatus comprises a top element (161) coupled to a bottom element (162) by a connecting spring (165). Each of the top and bottom elements comprises a top flange (163) and a bottom flange (164). The top flange of the top element engages with a cam (146) of the deadbolt lock mechanism (140). The bottom flange of the bottom element engages with a locking pin (136) of the handle lock mechanism (130). A plurality of standoffs (167) extends from the exterior body (110) and acts as guide rails (168) for the top element and the bottom element. Dampening springs (166) disposed between the top flange of the bottom element and two of the plurality of standoffs provide smoother movement during linear transfer. When the cam of the deadbolt lock mechanism rotates, the linkage apparatus transfers rotation of the cam into linear motion to engage the locking pin for actuation of the handle lock mechanism. Additionally, when the locking pin is unlocked due to rotation of an inner handle, the locking pin retracts inwards causing linear downward movement of the linkage apparatus. The linear downward movement of the linkage apparatus is transferred into rotation of the cam which causes actuation of the deadbolt lock mechanism. The linkage apparatus ensures that unlocking one mechanism simultaneously unlocks the other.

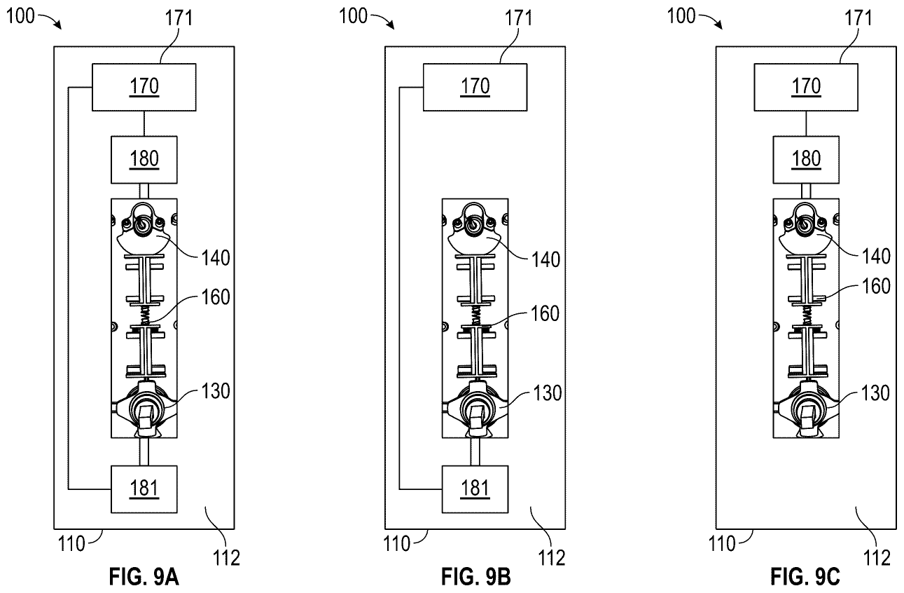

FIGS. 9A-9C show various embodiments of the double lock system (100). In some embodiments, the double lock system comprises two actuators, namely a first actuator (180) and a second actuator (181), to individually actuate the deadbolt lock mechanism (140) and the handle lock mechanism (130), respectively by the electronic control circuit (170). In other embodiments, the double lock system comprises only the second actuator which is mechanically coupled to the handle lock mechanism for actuation. Actuation of the deadbolt lock mechanism is done solely by the linkage apparatus (160). Alternatively, in other embodiments, the double lock system comprises only the first actuator mechanically coupled to the deadbolt lock mechanism with actuation of the handle lock performed solely by the linkage apparatus. As shown, the linkage apparatus is disposed within the exterior body (110), In other embodiments, the first actuator is disposed within the interior body and mechanical coupling of the first actuator to the handle lock mechanism is achieved by rotation of the deadbolt lock mechanism in the interior body thereby causing the deadbolt lock mechanism to rotate in the exterior body to translate the linkage apparatus for actuating the handle lock mechanism. As shown, the electronic control circuit is disposed within the exterior body. In other embodiments, the electronic control circuit is disposed within the interior body.

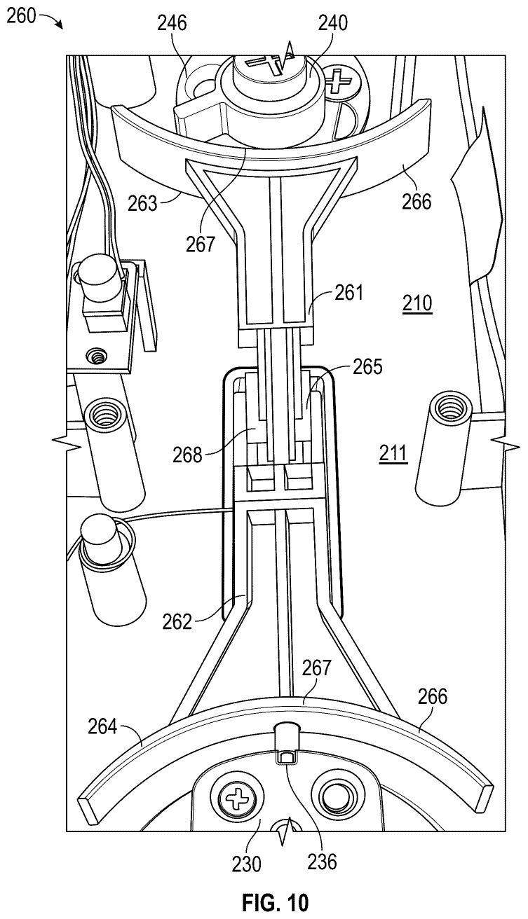

FIG. 10 shows a linkage apparatus (260) in a first inner cavity (212) of an exterior body (210). The linkage apparatus comprises a top element (261) coupled to a bottom element (262) by a connecting spring (265). The top element comprises a top flange (263) and the bottom element comprises a bottom flange (264). Both the top flange and the bottom flange comprise a concave formation (266) with a corresponding vertex (267). The top flange is engaged with a cam (246) of a deadbolt lock mechanism (240). The vertex of the bottom flange engages with a locking pin (236) of a handle lock mechanism (230). The connecting spring is secured and protected by a spring sheath (268). The connecting spring functions to let the handle lock mechanism or the deadbolt lock mechanism operate independently when a door is unlocked (or in passage mode) and operated manually. As shown the top flange is in a mirror configuration with the bottom flange.

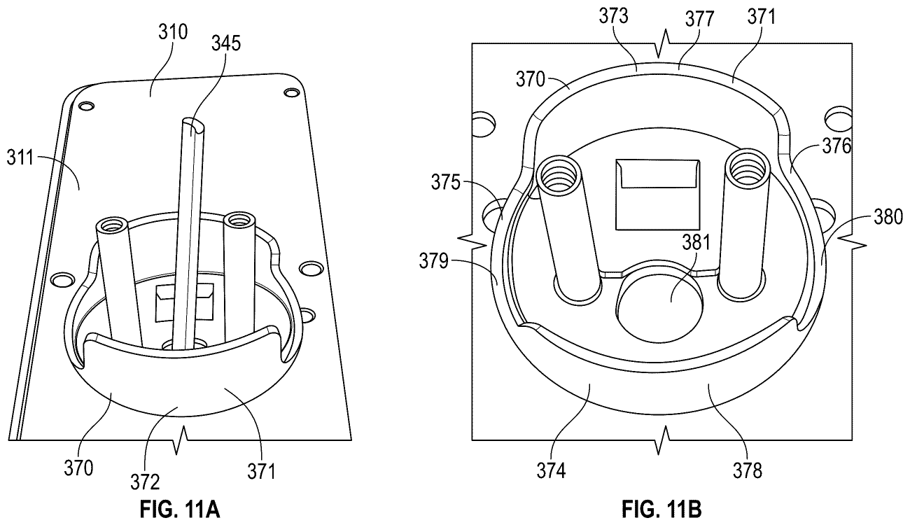

FIGS. 11A-B show a support adapter (370) in accordance with a third illustrated embodiment. The support adapter is coupled to an exterior body (310) at a first inner surface (311) thereof. The support adapter is disposed over a deadbolt lock mechanism (not shown) wherein a tailpiece (345) extends through the support adapter at a tailpiece aperture (381). The support adapter comprises a raised periphery (371) having a plurality of quadrants (372) for protecting the deadbolt lock mechanism. The plurality of quadrants includes a top quadrant (373), a bottom quadrant (374), a first lateral quadrant (375), and a second lateral quadrant (376). The top quadrant comprises a top periphery height (377), the bottom quadrant comprises a bottom periphery height (378), the first lateral quadrant comprises a first lateral periphery height (379), and the second lateral quadrant comprises a second lateral periphery height (380). The top periphery height and the bottom periphery height are each greater than the first lateral periphery height and the second lateral periphery height. The raised periphery protects components of the deadbolt lock mechanism from shifting from slamming of the associated door. In some embodiments the top periphery height is equal to the bottom periphery height.

### FEATURE LIST

door (10)
interior side (11)
exterior side (12)
lock edge (13)
double lock system (100)
upper region (102)
lower region (103)
exterior body (110; 210; 310)
first inner surface (111; 311)
first internal cavity (112)
first outer surface (113)
interior body (120)
second inner surface (121)
second internal cavity (122)
second outer surface (123)
harness aperture (124)
handle lock mechanism (130; 230)
outer handle (131)
inner handle (132)
spring latch (133)
deadlocking plunger (134)
spindle (135)
locking pin (136; 236)
deadbolt lock mechanism (140; 240; 340)
deadbolt (141)
deadbolt cylinder (142)
keyway (143)
thumb turn (144)
tailpiece (145; 345)
cam (146; 246)
touch pad (150)
mode selector (151)
linkage apparatus (160; 260)
top element (161; 261)
bottom element (162; 262)
top flange (163; 263)
bottom flange (164; 264)
connecting spring (165; 265)
dampening spring (166)
plurality of standoffs (167)
guide rail (168)
electronic control circuit (170)
first module (171)
second module (172)
circuit harness (173)
transceiver (174)
power supply (175)
gateway (176)
router (177)
first wireless communication protocol (178)
second wireless communication protocol (179)
first actuator (180)
second actuator (181)
plurality of locking modes (190)
standard mode (191)
passage mode (192)
locked mode (193)
concave formation (266)
vertex (267)
spring sheath (268)
support adapter (370)
raised periphery (371)
plurality of quadrants (372)
top quadrant (373)
bottom quadrant (374)
first lateral quadrant (375)
second lateral quadrant (376)
top periphery height (377)
bottom periphery height (378)
first lateral periphery height (379)
second lateral periphery height (380)
tailpiece aperture (381)

What is claimed is:

1. A double lock system, comprising:
an exterior body having a first inner surface, a first outer surface opposite the first inner surface, and a first internal cavity disposed between the first inner surface and the first outer surface, wherein the first inner surface is configured to abut an exterior side of a door;
an interior body mechanically and electrically coupled to the exterior body, the interior body having a second inner surface, a second outer surface opposite the second inner surface, and a second internal cavity disposed between the second inner surface and the second outer surface, wherein the second inner surface is configured to abut an interior side of a door;
a handle lock mechanism integrated within each of the interior body and the exterior body, the handle lock mechanism comprising an outer handle disposed on the first outer surface of the exterior body and an inner handle disposed on the second outer surface of the interior body, the handle lock mechanism further comprising a locking pin disposed inside at least one of the first internal cavity or the second internal cavity;
a deadbolt lock mechanism integrated within each of the interior body and the exterior body, the deadbolt lock mechanism comprising a cam and a deadbolt cylinder, the deadbolt cylinder disposed on the first outer surface of the exterior body, the deadbolt cylinder having a keyway configured to receive a key for manual actuation of a deadbolt, the deadbolt lock mechanism further comprising a thumb turn disposed on the interior body at the second outer surface, the thumb turn being mechanically coupled to the deadbolt;
a transceiver disposed inside at least one of the first internal cavity and the second internal cavity;
a linkage apparatus disposed inside one of the first internal cavity or the second internal cavity, the linkage apparatus coupled to both the handle lock mechanism and the deadbolt lock mechanism to form a synchronous coupling between the handle lock mechanism and the deadbolt lock mechanism, the linkage apparatus comprising:
a top element comprising a top flange, the top flange engaged with the cam of the deadbolt lock mechanism,
a bottom element comprising a bottom flange, the bottom flange engaged with the locking pin of the handle lock mechanism, and
a connecting spring coupling the top element to the bottom element; and
an actuator coupled to the deadbolt lock mechanism wherein actuation of the deadbolt cylinder synchronously actuates the handle lock mechanism via the linkage apparatus.

2. The double lock system of claim 1, the double lock system further comprising a mode selector disposed on the second outer surface of the interior body, wherein the mode selector is configured to be manually pressed to alter locking modes of the double lock system.

3. The double lock system of claim 1, the double lock system further comprising a single cylinder configured to unlock both the handle lock mechanism and the deadbolt lock mechanism, wherein the single cylinder is the deadbolt cylinder integrated with the deadbolt lock mechanism.

4. The double lock system of claim 1, further comprising a router and a gateway communicatively coupled to the router by a first wireless communication protocol, the gateway further communicatively coupled to the transceiver by a second wireless communication protocol, wherein the first wireless communication protocol is different from the second wireless communication protocol.

5. The double lock system of claim 1, further comprising a spring sheath covering the connecting spring.

6. The double lock system of claim 1, wherein the top flange and the bottom flange each comprise a concave formation.

7. A double lock system, comprising:
an exterior body having a first inner surface, a first outer surface opposite the first inner surface, and a first internal cavity disposed between the first inner surface and the first outer surface, wherein the first inner surface is configured to abut an exterior side of a door;
an interior body coupled to the exterior body, the interior body having a second inner surface, a second outer surface opposite the second inner surface, and a second internal cavity disposed between the second inner surface and the second outer surface, wherein the second inner surface is configured to abut an interior side of a door;
a handle lock mechanism integrated within each of the interior body and the exterior body; and
a deadbolt lock mechanism integrated within each of the interior body and the exterior body;
wherein the handle lock mechanism is synchronously coupled to the deadbolt lock mechanism for simultaneous actuation.

8. The double lock system of claim 7, wherein the interior body is electrically coupled and mechanically coupled to the exterior body.

9. The double lock system of claim 7, the handle lock mechanism further comprising an outer handle disposed on the first outer surface of the exterior body and an inner handle disposed on the second outer surface of the interior body.

10. The double lock system of claim 7, the deadbolt lock mechanism further comprising a deadbolt cylinder disposed on the first outer surface of the exterior body, the deadbolt cylinder including a keyway configured to receive a key for manual actuation of a deadbolt.

11. The double lock system of claim 10, the deadbolt lock mechanism further comprising a thumb turn disposed on the interior body at the second outer surface, the thumb turn being mechanically coupled to the deadbolt.

12. The double lock system of claim 10, wherein the handle lock mechanism is coupled to the deadbolt cylinder wherein actuation of the deadbolt cylinder synchronously actuates the handle lock mechanism.

13. The double lock system of claim 7, the double lock system further comprising a mode selector disposed on the second outer surface of the interior body, wherein the mode selector is configured to be manually pressed to alter locking modes of the double lock system.

14. The double lock system of claim 7, the double lock system further comprising a single cylinder configured to unlock both the handle lock mechanism and the deadbolt lock mechanism, wherein the single cylinder is a deadbolt cylinder integrated with the deadbolt lock mechanism.

15. The double lock system of claim 7, the double lock system further comprising a transceiver for receiving signals for remote actuation.

16. The double lock system of claim 15, further comprising a router and a gateway communicatively coupled to the router by a first wireless communication protocol, the gateway further communicatively coupled to the transceiver by a second wireless communication protocol, wherein the first wireless communication protocol is different from the second wireless communication protocol.

17. The double lock system of claim 7, further comprising a linkage apparatus coupled to both the deadbolt lock mechanism and the handle lock mechanism.

18. The double lock system of claim 17, further comprising an actuator coupled to the deadbolt lock mechanism.

19. The double lock system of claim 17, the linkage apparatus further comprising a top element and a bottom element coupled together by a connecting spring, wherein the top element comprises a top flange and the bottom element comprises a bottom flange.

20. The double lock system of claim 7, further comprising a support adapter coupled to the first inner surface of the exterior body, the support adapter comprising a raised periphery, the raised periphery having a plurality of quadrants comprising a top quadrant, a bottom quadrant, a first lateral quadrant, and a second lateral quadrant wherein the raised periphery at the top quadrant and the bottom quadrant is taller than the raised periphery at the first lateral quadrant and the second lateral quadrant.
